(19) United States
(12) Patent Application Publication
(10) Pub. No.: US 2025/0175910 A1
(43) Pub. Date: May 29, 2025

(54) SYSTEMS AND METHODS FOR SIMULTANEOUS BACKHAUL LINK AND CONTROL LINK TRANSMISSIONS FOR NETWORK NODES

(71) Applicant: ZTE CORPORATION, Shenzhen (CN)

(72) Inventors: Ziyang LI, Shenzhen (CN); Nan ZHANG, Shenzhen (CN); Wei CAO, Shenzhen (CN); Hanqing XU, Shenzhen (CN); Shuang ZHENG, Shenzhen (CN)

(73) Assignee: ZTE CORPORATION, Shenzhen (CN)

(21) Appl. No.: 19/037,960

(22) Filed: Jan. 27, 2025

Related U.S. Application Data
(63) Continuation of application No. PCT/CN2023/074175, filed on Feb. 2, 2023.

(51) Int. Cl. H04W 52/36; H04L 5/00; H04W 84/04

(52) U.S. Cl. CPC H04W 52/367; H04L 5/0053; H04W 84/047

(57) ABSTRACT

Presented are systems and methods for simultaneous backhaul link and control link transmissions for network nodes. A network node can determine (i) a first power of the network node for a control link from the network node to a wireless communication node, and (ii) a second power of the network node for a forwarding link from the network node to the wireless communication node. The network node can perform at least one of (i) sending a first signal via the control link from the network node to the wireless communication node, and (ii) forwarding a second signal via the forwarding link from the network node to the wireless communication node.

### CROSS-REFERENCE TO RELATED APPLICATION

This application claims the benefit of priority under 35 U.S.C. § 120 as a continuation of PCT Patent Application No. PCT/CN2023/074175, filed on Feb. 2, 2023, the disclosure of which is incorporated herein by reference in its entirety.

### TECHNICAL FIELD

The disclosure relates generally to wireless communications, including but not limited to systems and methods for simultaneous backhaul link and control link transmissions for network nodes.

### BACKGROUND

Coverage is a fundamental aspect of cellular network deployments. Mobile operators rely on different types of network nodes to offer blanket coverage in their deployments. As a result, new types of network nodes have been considered to increase the flexibility of mobile operators for their network deployments. For example, certain systems or architectures introduce integrated access and backhaul (IAB), which may be enhanced in certain other systems, as a new type of network node not requiring a wired backhaul. Another type of network node is the RF repeater which simply amplify-and-forward any signal that they receive. RF repeaters have seen a wide range of deployments in 2G, 3G, and 4G to supplement the coverage provided by regular full-stack cells.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A network node (e.g., smart node (SN)) can determine (i) a first power of the network node for a control link from the network node to a wireless communication node (e.g., base station (BS), gNB, or transmission and reception point (TRP)), and (ii) a second power of the network node for a forwarding link from the network node to the wireless communication node. The network node can perform/initiate/execute at least one of (i) sending a first signal via the control link from the network node to the wireless communication node, and/or (ii) forwarding a second signal via the forwarding link from the network node to the wireless communication node.

In some implementations, when a transmission on the control link and a transmission on the forwarding link occur simultaneously, at least one of: the first power can be lower than or equal to a first maximum power configured for the control link; and/or the second power can be lower than or equal to a second maximum power configured for the forwarding link. In some implementations, when a transmission on the control link and a transmission on the forwarding link occur simultaneously, at least one of: a sum of a maximum value of the first power and a maximum value of the second power is less than or equal to a total maximum power, where the total maximum power can be a part of a capability of the network node; or the maximum value of the first power is unrelated to the maximum value of the second power; or at least one of the maximum value of the first power or the maximum value of the second power is configured by the wireless communication node; or at least one of the maximum value of the first power or the maximum value of the second power is determined based on a total maximum power minus another one of the maximum value of the first power or the maximum value of the second power, where the total maximum power can be a part of a capability of the network node.

In some implementations, when a total power of the first power and the second power exceeds a total maximum power, and/or when a transmission on the control link and a transmission on the forwarding link occur simultaneously, the method can comprise one of: determining to perform A, which can comprise: allocating no power to the second power, or determining not to perform the forwarding of the second signal; determining to perform B, which can comprise: allocating no power to the first power, or determining not to send the first signal; or determining to perform A or B, according to a prioritization rule. In some implementations, the prioritization rule can indicate to perform forwarding or sending of at least one signal having a highest priority among signals that matched candidate signals identified in the prioritization rule.

In some implementations, the prioritization rule can identify at least one of following candidate signals for the first signal, as having higher priority than a candidate signal for the second signal: a physical random access channel (PRACH) transmission, a physical uplink control channel (PUCCH) transmission, a PUCCH transmission with hybrid automatic repeat request acknowledgement (HARQ-ACK) information, a physical uplink shared channel (PUSCH) transmission with HARQ-ACK information, a sounding reference signal (SRS), a PUCCH transmission with status report, and/or a PUSCH transmission with status report.

In some implementations, the prioritization rule can identify/indicate/provide at least one of following candidate signals for the first signal, as having lower priority than a candidate signal for the second signal: a signal other than a physical random access channel (PRACH) transmission, a signal other than a physical uplink control channel (PUCCH) transmission, a signal other than a PUCCH transmission with hybrid automatic repeat request acknowledgement (HARQ-ACK) information, a signal other than a physical uplink shared channel (PUSCH) transmission with HARQ-ACK information, a signal other than a sounding reference signal (SRS), a signal other than a PUCCH transmission with status report, and/or a signal other than a PUSCH transmission with status report.

In some implementations, the prioritization rule can identify/list/specify, in order of descending priority, a first candidate signal for the first signal, a second candidate signal for the second signal, and a third candidate signal for the first signal, respectively, as comprising: {a physical random access channel (PRACH) transmission, or a physical uplink control channel (PUCCH) transmission; any signal; a signal other than a PRACH transmission or a PUCCH transmission}; and/or {a PRACH transmission, or a PUCCH transmission with hybrid automatic repeat request acknowledgement (HARQ-ACK) information; any signal; a signal other than a PRACH transmission or a PUCCH transmission with HARQ-ACK information}; and/or {a PRACH transmission, a PUCCH transmission with HARQ-ACK information, or a physical uplink shared channel (PUSCH) transmission with HARQ-ACK information; any signal; a signal other than a PRACH transmission, a PUCCH transmission with HARQ-ACK information or a PUSCH transmission with HARQ-ACK information}; and/or {a PUCCH transmission with HARQ-ACK information; any signal; a signal other than a PUCCH transmission with HARQ-ACK information}; and/or {a PUCCH transmission with HARQ-ACK information, or a physical uplink shared channel (PUSCH) transmission with HARQ-ACK information; any signal; a signal other than a PUCCH transmission with HARQ-ACK information or a PUSCH transmission with HARQ-ACK information}; and/or {a PUCCH transmission with HARQ-ACK, or a sounding reference signal (SRS) information; any signal; a signal other than a PUCCH transmission with HARQ-ACK information or a SRS}; and/or {a PRACH transmission, a PUCCH transmission with HARQ-ACK information, or a SRS; any signal; a signal other than a PRACH transmission, a PUCCH transmission with HARQ-ACK information or a SRS}; and/or {a PRACH transmission, or a PUCCH transmission with status report; any signal; a signal other than a PRACH transmission or a PUCCH transmission with status report}; and/or {a PRACH transmission, a PUCCH transmission with status report, or a PUSCH transmission with status report; any signal; a signal other than a PRACH transmission or a PUCCH transmission with status report or a PUSCH transmission with status report}.

In some implementations, when the network node determines/decides/proceeds to perform B, the network node can transmit/send/provide/signal/communicate the first signal in a frequency domain resource allocated to the first signal that was not previously transmitted/forwarded. In some implementations, when the first signal comprises/includes a physical random access channel (PRACH) transmission, then at least one of: the PRACH transmission can be transmitted in a next random access channel (RACH) occasion (RO); the PRACH transmission can be transmitted in a next PRACH slot; and/or the PRACH transmission can be transmitted according to: a synchronization signal block (SSB) determined by the network node, and a relationship between the SSB and the PRACH transmission.

In some implementations, when the first signal comprises a physical uplink control channel (PUCCH) transmission, a physical uplink shared channel (PUSCH) transmission, and/or a sounding reference signal (SRS), then at least one of: the first signal can be transmitted in a next slot; the first signal can be transmitted in a next uplink slot; the first signal can be transmitted in a time domain resource according to an indication from the wireless communication node; and/or the first signal can be transmitted after a defined duration.

In some implementations, the network node can determine/proceed to prioritize the sending of the first signal. The network node can reduce/decrease/lower the second power to be a smaller one of: (i) a maximum total power minus the first power, and/or (ii) an input power to the network node multiplied by a configured gain of the network node. In some implementations, the network node can adjust/change/update/configure an actual gain of the network node, such that: the input power multiplied by the actual gain is smaller than (e.g., less than) or equal to the maximum total power minus the first power.

In some implementations, the network node can determine/proceed to prioritize the forwarding of the second signal. The network node can determine the first power to be a smaller one of: (i) a maximum total power, and/or (ii) an input power to the network node multiplied by a configured gain of the network node. In some implementations, the network node can determine the first power to be a smaller one of: (i) the maximum total power minus the second power, and/or (ii) a value of the first power specific to a type of the first signal.

In some implementations, the network node can determine/calculate/compute the first power to be: a value of the first power specific to a type of the first signal, minus a power offset. In some implementations, the power offset can be at least one of: no less than: the value of the first power specific to the type of the first signal, plus the determined second power, minus the maximum total power; a fixed value; and/or configured by the wireless communication node.

In some implementations, the network node can receive/obtain/acquire an indication for adjusting the second power. The network node can adjust the second power according to the indication. In some implementations, the indication can comprise at least one of: an indication of a transmission power value for the second power, wherein at least one of: (i) a gain of the network node can be determined/computed/calculated based on the transmission power value divided by an input power to the network node, and/or (ii) a sum of the transmission power value and the first power is less than a maximum total power; an indication of the gain, wherein at least one of: (i) the second power is a smaller one of: (a) the maximum total power minus a value of the first power specific to a type of the first signal, and/or (b) the input power to the network node multiplied by a configured gain of the network node; and/or (ii) the gain is such that: the input power multiplied by the gain is smaller than or equal to the maximum total power minus the first power; an indication of a frequency domain resource for the second power, comprising at least one of: a frequency offset, a resource block (RB) number or a resource element (RE) number, a bandwidth part (BWP) index, a band index, and/or a frequency domain resource allocation (FDRA) indicator; and/or an indication of a time domain resource for the second power, comprising at least one of: a slot offset, a symbol offset, a duration, a periodicity, a system frame number (SFN), a start and length indicator value (SLIV), a number of absolute time units, and/or an absolute time unit.

At least one aspect is directed to a system, method, apparatus, or a computer-readable medium. A wireless communication node can receive/obtain/acquire at least one of (i) a first signal via a control link from a network node to the wireless communication node, and/or (ii) a second signal via a forwarding link from the network node to the wireless communication node. The network node can determine (i) a first power of the network node for the control link from the network node to the wireless communication node, and/or (ii) a second power of the network node for the forwarding link from the network node to the wireless communication node.

The systems and methods presented herein include a novel approach for simultaneous backhaul link and control link (C-link) transmissions for network nodes. Specifically, the systems and methods presented herein discuss a novel solution for prioritizing one of the C-link or the backhaul link transmissions to avoid the total power of the simultaneous C-link and backhaul link transmissions from exceeding the maximum power restriction/threshold/cap (e.g., maximum power threshold). In some example implementations, if the sum of the control link (C-link) power and the backhaul link power exceeds the total maximum power restriction, drop one of the links according to or following at least one predefined rule. In case the C-link is dropped according to the at least one predefined rule, the smart node (SN) communication unit (CU) (e.g., network controlled repeater (NCR)-mobile terminal (MT)) can re-transmit/resend the dropped signal in the same frequency domain resource.

In some example implementations, the C link and backhaul link may share the total maximum power restriction and the output power of the C link can be prioritized. In some example configurations, the C link and backhaul link may share the total maximum power restriction and the output power of the backhaul link can be prioritized. In some example arrangements, the wireless communication node (e.g., gNB, BS, or TRP) can transmit power control indication to NCR to adjust the output power for backhaul link, for instance, to ensure that the sum of power for C-link and backhaul link does not exceed the total maximum power restriction. The power control indication can include at least one of:
Transmission power:
   If the transmission power is indicated, the amplifying gain can be calculated as: amplifying gain=transmission power/input power.
   The sum of the transmit power for the backhaul link and C-link can be less than the maximum total power.
Amplifying gain:
   If the amplifying gain is indicated, the transmission power can be determined/computed/calculated as: transmission power=min (max total power-C link power, input power×amplifying gain).
Frequency resource.
Time resource.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a schematic diagram of an example network, in accordance with some embodiments of the present disclosure;

FIG. 4 illustrates a schematic diagram of transmission links between BS to SN and SN to UE, in accordance with some embodiments of the present disclosure;

FIG. 5 illustrates an example of an implementation structure for simultaneous backhaul link and control link transmissions, in accordance with some embodiments of the present disclosure; and

FIG. 6 illustrates a flow diagram of an example method for simultaneous backhaul link and control link transmissions, in accordance with an embodiment of the present disclosure.

### DETAILED DESCRIPTION

### 1. Mobile Communication Technology and Environment

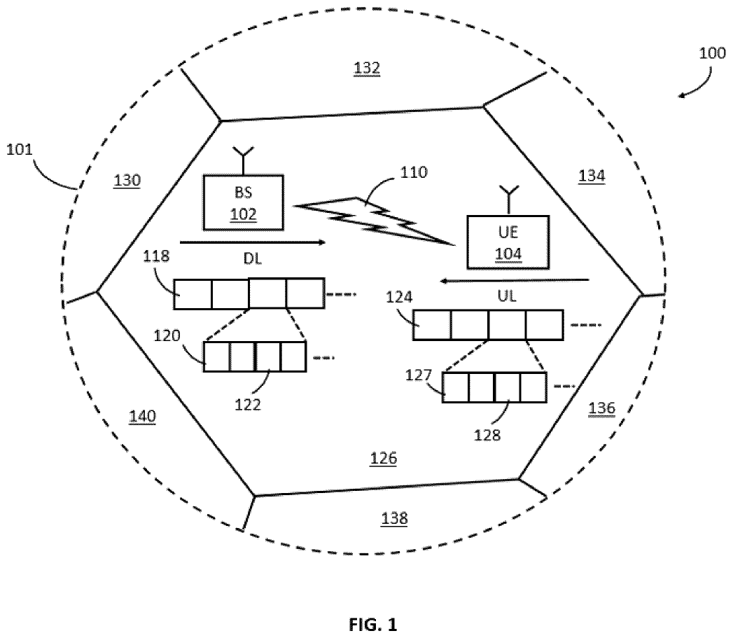

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

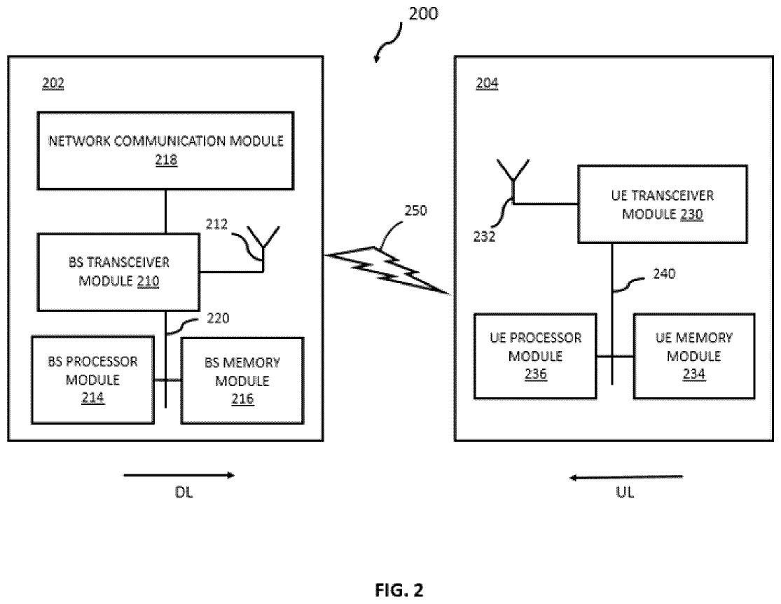

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communicate with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Simultaneous Backhaul Link and Control Link Transmissions for Network Nodes

In certain systems (e.g., 5G new radio (NR), Next Generation (NG) systems, 3GPP systems, and/or other systems), different types of network nodes can be utilized to enhance coverage in cellular network deployments (e.g., offer blanket coverage). New types of network nodes may be introduced or considered to increase flexibility in their network deployments. For example, IAB can be deployed as a new type of network node not requiring a wired backhaul. Another type of network node can be the RF repeater. The RF repeaters can be deployed or configured to receive, amplify, and forward any signal. The RF repeaters can be deployed in various network environments to supplement the coverage provided by, for instance, regular full-stack cells.

A network-controlled repeater (NCR) can be introduced as an enhancement over conventional RF repeaters with the capability to receive and/or process side control information from the network. Side control information can allow a network-controlled repeater to perform/execute/operate its amplify-and-forward operation in a more efficient manner. Certain benefits can include at least mitigation of unnecessary noise amplification, transmissions and receptions with better spatial directivity, and/or simplified network integration.

The NCR can be regarded as a stepping stone (e.g., a variant, alternative or modification) of a re-configurable intelligent surface (RIS). A RIS node can adjust the phase and amplitude of the received signal to improve/enhance the coverage (e.g., network communication coverage). As discussed herein, network nodes, including and not limited to network-controlled repeater, smart repeater, enhanced RF repeaters, re-configuration intelligent surface (RIS), and/or integrated access and backhaul (IAB), can be denoted, referred to, or provided as a smart node (SN) (e.g., network node) for simplicity. For example, the SN can include, correspond to, or refer to a kind of network node to assist the BS 102 to improve coverage (e.g., avoiding/averting blockage/obstructions, increasing transmission range, etc.). In certain systems, the SN may initiate/perform control-link (C-link) and backhaul link transmissions simultaneously (e.g., at relatively the same time). The simultaneous transmission via the C-link and the backhaul link may consume a certain amount of power beyond a maximum power threshold. Therefore, the systems and methods of the technical solution can perform features, operations, techniques, and/or methods discussed herein to prioritize one of the C-link or the backhaul link to avoid the total power of simultaneous C-link and backhaul link transmissions exceeding the maximum power restriction. As discussed herein, the systems and methods can prioritize the C-link or the backhaul link by dropping one of the transmissions or configuring/adjusting the power of the C-link transmission and/or the backhaul link transmission.

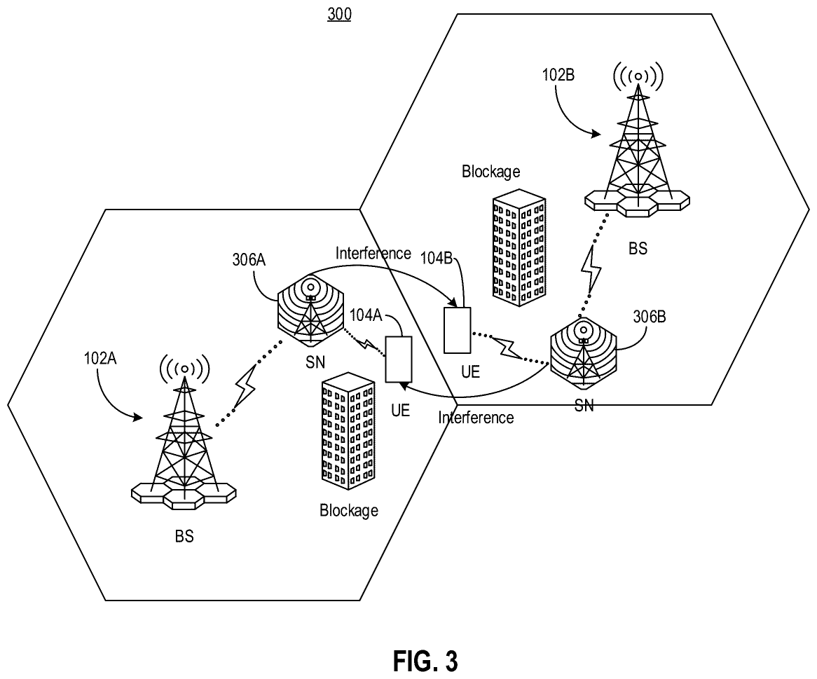

FIG. 3 illustrates a schematic diagram of an example network 300. As illustrated in FIG. 3, one or more BSs 102A-B (e.g., BSs 102) can serve one or more UEs 104A-B (e.g., UEs 104) respectively in their cells via the respective one or more SNs 306A-B (e.g., sometimes labeled as SN(s) 306), such as when there are blockages between the BS(s) 102 and the UE(s) 104.

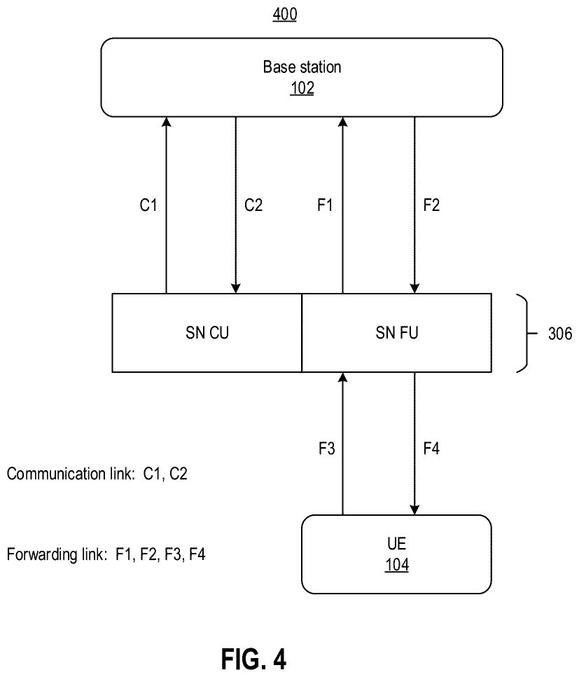

FIG. 4 illustrates a schematic diagram 400 of transmission links between BS 102 to SN 306 and SN 306 to UE 104. The SN 306 (e.g., network node) can include or consist of at least two units or functional parts/components (e.g., sometimes referred to as function entities), such as the communication unit (CU) (e.g., SN CU) and the forwarding unit (FU) (e.g., SN FU). The units of the SN 306 can support different functions for communication with at least one of the BS 102 and/or the UE 104. A first unit (or function entity) of the SN 306 may refer to the SN CU and a second unit (or function entity) of the SN 306 may refer to the SN FU or vice versa, in some cases. For example, the SN CU (e.g., first unit) can be a network-controlled repeater (NCR) mobile terminal (MT). In another example, the SN FU (e.g., second unit) can be an NCR forwarder/forwarding (Fwd). The SN CU can act/behave or include features similar to a UE 104, for instance, to receive and decode side control information from the BS 102. The SN CU may be a control unit, controller, MT, part of a UE, a third-party IoT device, and so on. The SN FU can carry out the intelligent amplify-and-forward operation using the side control information received by the SN CU. The SN FU may be a radio unit (RU), a RIS, and so on.

The transmission links between the BS 102 to SN 306 and the SN 306 to UE 104 as shown in FIG. 4 can be defined/described/provided as follows:
C1: Control link (C-link) from SN CU to BS;
C2: Control link (C-link) from BS to SN CU;
F1: Forwarding link (backhaul link) from SN FU to BS;
F2: Forwarding link (backhaul link) from BS to SN FU;
F3: Forwarding link (access link) from UE to SN FU; and
F4: Forwarding link (access link) from SN FU to UE.

Control link (e.g., sometimes referred to as a communication link) can refer to or mean that the signal from one side will be detected and decoded by the other side, so that the information transmitting in the control link can be utilized to control the status of forwarding links (e.g., backhaul links and/or access links, F-link). In some implementations, the control link may correspond to or be referred to as communication link.

Forwarding link can mean that the signal from BS 102 or UE 104 is unknown to (e.g., undecoded or uninspected by) SN FU. In this case, the SN FU can amplify and forward signals without decoding them. For example, the F1 and F3 links can correspond to or be associated with the complete uplink (UL) forwarding link (e.g., backhaul link and access link, respectively) from UE 104 to BS 102, in which F1 is the SN FU UL forwarding link. Additionally, the F2 and F4 links can correspond to or be associated with the complete DL forwarding link (e.g., backhaul link and access link, respectively) from BS 102 to UE 104, in which F4 is the SN FU DL forwarding link. The F1 and F2 links can correspond to or be referred to as backhaul links and F3 and F4 links can correspond to or be referred to as access links.

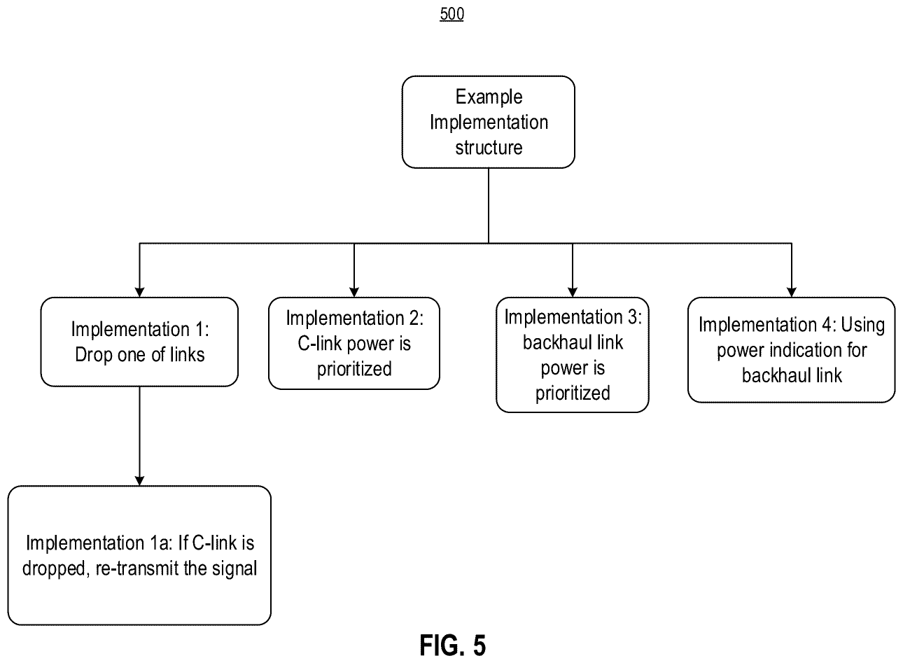

Referring to FIG. 5, an example of an implementation structure 500 for simultaneous backhaul link and control link transmissions is depicted, in accordance with some embodiments of the present disclosure. For simultaneous backhaul link and C-link transmissions (e.g., F1 and C1, respectively), the total power of the two transmissions (e.g., the sum of C-link and backhaul link powers) is expected to be less than or equal to (e.g., not exceeding) the total maximum power restriction/limit/cap (e.g., maximum power threshold). The following example features can be considered to avoid the total power of the two transmissions exceeding the total maximum power restriction.

In some configurations, the signal/channel in the backhaul link (e.g., F1) can be transparent to the SN 306, e.g., SN FU (or NCR Fwd) may forward the signal from the UE 104 to the BS 102 without being aware of the content of the signal. In some configurations, the total maximum power may be a fixed value. In some other configurations, the total maximum power can be adjusted according to or based on the capability of the SN 306.

In various implementations of the present disclosure, unless explicitly indicated/mentioned/provided (e.g., in example implementation 3), the power of the C-link can be determined/computed/calculated based on certain systems' UE power control mechanisms for different channels, e.g., physical uplink control channel (PUCCH) transmission, physical uplink shared channel (PUSCH) transmission, physical random access channel (PRACH), and/or sounding reference signal (SRS), among other types of channels. In some implementations, the C-link power calculation formulas can be presented/described/shown as follows:
If C-link transmits PUSCH, the C-link power can be computed as:

$${P}_{PUSCH , b , f , c} ( i , j , {q}_{d} , l ) = min \{ \begin{matrix}{P}_{CMAX , f , c} ( i ) , \\ \begin{matrix}{P}_{{O}_{PUSCH} , b , f , c} ( j ) + 10 {log}_{10} ( {2}^{μ} \cdot {M}_{RB , b , f , c}^{PUSCH} ( i ) ) + \\ {a}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} \} [ dBm ] \qquad ( 1 )$$

If C-link transmits PUCCH, the C-link power can be computed as:

$${P}_{PUCCH , b , f , c} ( i , {q}_{u} , {q}_{d} , l ) = min \{ \begin{matrix}{P}_{CMAXf , c} ( i ) , \\ \begin{matrix}{P}_{{O}_{PUCCH} , b , f , c} ( {q}_{u} ) + 10 {log}_{10} ( {2}^{u} \cdot {M}_{RB , b , f , c}^{PUCCH} ( i ) ) + \\ {PL}_{b , f , c} ( {q}_{d} ) + {Δ}_{F \_ PUCCH} ( F ) + {Δ}_{TF , b , f , c} ( i ) + {g}_{b , f , c} ( i , l )\end{matrix}\end{matrix} \} [ dBm ] \qquad ( 2 )$$

If C-link transmits PRACH, the C-link power can be computed as:

$${P}_{P R A C H b , f , c} ( i ) = min \{ {P}_{CMAXf , c} ( i ) , {P}_{PRACHtarget , f , c} + {PL}_{b , f , c} \} [ dBm ] \qquad ( 3 )$$

If C-link transmits SRS, the C-link power can be computed as:

$${P}_{SRS , b , f , c} ( i , {q}_{s} , l ) = min \{ \begin{matrix}{P}_{CMAX , f , c} ( i ) , \\ \begin{matrix}{P}_{{O}_{SRS} , b , f , c} ( {q}_{s} ) + 10 {log}_{10} ( {2}^{u} \cdot {M}_{SRS , b , f , c} ( i ) ) + {a}_{SRS , b , f , c} ( {q}_{s} ) \cdot \\ {PL}_{b , f , c} ( {q}_{d} ) + {h}_{b , f , c} ( i , l )\end{matrix}\end{matrix} \} [ dBm ] \qquad ( 4 )$$

### Example Implementation 0: Separate/Different Maximum Power Restrictions (or Thresholds) Configured For Backhaul Link and C-Link

In some implementations, the backhaul link and the C-link can be configured with separate maximum power restrictions. In this case, if the C-link and backhaul link are transmitted/sent/forwarded simultaneously (e.g., signals configured to be transmitted via the C-link and backhaul link at the same time), the power of or associated with C-link may be lower than a first maximum power restriction, and/or the power of backhaul link may be lower than a second maximum power restriction. The first maximum power restriction can be different from the second maximum power restriction. In some implementations, both the first maximum power restriction/threshold and the second maximum power restriction can be configured by the BS 102. In some implementations, at least one of the first maximum power restriction and/or the second maximum power restriction can be calculated/determined by/based on/according to the total maximum power restriction minus another one of the first maximum power restriction and the second maximum power restriction.

The C-link power can be determined/calculated according to the formulas for different signals/channels (e.g., determined C-link power). As such, the actual C-link power can be the minimum of either the first maximum power restriction or the determined C-link power (e.g., min (first maximum power restriction, determined C-link power)).

The backhaul link power can be determined/calculated as the minimum of either the second maximum power restriction or the product of the input power and the (configured) amplifying gain (e.g., min (second maximum power restriction, input power×amplifying gain)). In some implementations, the configured amplifying gain can be applied for different scenarios, such as simultaneous C-link and backhaul link transmissions, TDMed C-link and backhaul link transmissions, etc. In some implementations, the sum of the first maximum power restriction and the second maximum power restriction can be less than or equal to (e.g., not larger than) the total maximum power restriction (e.g., the third maximum power restriction), thereby avoiding the total maximum power between the C-link and backhaul link transmissions exceeding the total maximum power restriction. In some implementations, the first maximum power restriction may not be related to the second maximum power restriction. For example, SN CU (e.g., NCR MT) and SN FU (e.g., NCR Fwd) may have separate radio frequency (RF) components. In various implementations, the signal associated with the C-link may be referred to as a first signal, the power associated with the C-link transmission may be referred to as a first power, the signal associated with the backhaul link may be referred to as a second signal, and the power associated with the backhaul link may be referred to as a second power.

### Embodiment 1: Sum of C-link and Backhaul Link Power Exceeds Total Maximum Power Restriction

In some implementations, responsive to the SN 306 (e.g., network node) computing the total power (e.g., the sum of the C-link power and backhaul link power) consumed by the simultaneous C-link and backhaul link transmissions, the SN 306 may determine whether the total power exceeds the total maximum power restriction. If the total power exceeds the total maximum power restriction, the SN 306 can drop/cancel/terminate/skip/bypass the transmission of one of the links (e.g., perform the transmission on one of the links) according to the following predefined/predetermined/configured rule (e.g., sometimes referred to as prioritization rule).

The prioritization rule can include/comprise at least one of the following:
C-link may be dropped if the total power exceeds the total maximum power restriction, regardless of which signal/channel is transmitted, and the backhaul link can be maintained (e.g., transmit via backhaul link).
   In this case, the backhaul link can be prioritized over the C-link. The C-link transmission may not affect the backhaul link forwarding.
Backhaul link can be dropped if the total power exceeds the total maximum power restriction, and C-link can be maintained regardless of which signal/channel is transmitted.
   In this case, the C-link can be prioritized over the backhaul link. The C-link transmission may not be affected by the backhaul link forwarding.
C-link {PRACH transmission, PUCCH transmission}>backhaul link>C-link other channels/signals.
   In this case, the priority of the C-link can depend on the specific/exact transmission signal of the C-link, and the link (e.g., either C-link or backhaul link) with lower priority can be dropped. For example, if the C-link transmits PRACH and/or PUCCH, the backhaul link can be dropped. In further example, if the C-link transmits other signals (e.g., PUSCH and/or SRS), the C-link can be dropped.
C-link {PRACH transmission, PUCCH transmission with HARQ-ACK information}>backhaul link>C-link other channels/signals.
   In this case, the priority of the C-link can depend on the specific/exact transmission signal of the C-link, and the link (e.g., either C-link or backhaul link) with lower priority can be dropped. For example, if the C-link transmits PRACH and/or PUCCH with HARQ-ACK information, the backhaul link can be dropped. In further example, if the C-link transmits other signals (e.g., PUSCH and/or SRS), the C-link can be dropped.
C-link {PRACH transmission, PUCCH transmission with HARQ-ACK information, PUSCH transmission with HARQ-ACK information}>backhaul link>C-link other channels/signals.
   In this case, the priority of the C-link can depend on the specific/exact transmission signal of the C-link, and the link (e.g., either C-link or backhaul link) with lower priority can be dropped. For example, if the C-link transmits PRACH, PUCCH with HARQ-ACK information, and/or PUSCH with HARQ-ACK information, the backhaul link can be dropped.
In further example, if the C-link transmits other signals (e.g., PUSCH with other information and/or SRS), the C-link can be dropped.
   C-link {PUCCH transmission with HARQ-ACK information}>backhaul link>C-link other channels/signals.

In this case, the priority of the C-link can depend on the specific/exact transmission signal of the C-link, and the link (e.g., either C-link or backhaul link) with lower priority can be dropped. For example, if the C-link transmits PUCCH with HARQ-ACK information, the backhaul link can be dropped. In further example, if the C-link transmits other signals (e.g., PUSCH and/or SRS), the C-link can be dropped.
C-link {PUCCH transmission with HARQ-ACK information, PUSCH transmission with HARQ-ACK information}>backhaul link>C-link other channels/signals.
   In this case, the priority of the C-link can depend on the specific/exact transmission signal of the C-link, and the link (e.g., either C-link or backhaul link) with lower priority can be dropped. For example, if the C-link transmits PUCCH with HARQ-ACK information and/or PUSCH with HARQ-ACK information, the backhaul link can be dropped. In further example, if the C-link transmits other signals (e.g., PUSCH with other information and/or SRS), the C-link can be dropped.
C-link {PUCCH transmission with HARQ-ACK information, SRS}>backhaul link>C-link other channels/signals.
   In this case, the priority of the C-link can depend on the specific/exact transmission signal of the C-link, and the link (e.g., either C-link or backhaul link) with lower priority can be dropped. For example, if the C-link transmits PUCCH with HARQ-ACK information and/or SRS, the backhaul link can be dropped. In further example, if the C-link transmits other signals (e.g., PRACH, PUCCH with other information, PUSCH, etc.), the C-link can be dropped.
C-link {PRACH, PUCCH transmission with HARQ-ACK information, SRS}>backhaul link>C-link other channels/signals.
   In this case, the priority of the C-link can depend on the specific/exact transmission signal of the C-link, and the link (e.g., either C-link or backhaul link) with lower priority can be dropped. For example, if the C-link transmits PRACH, PUCCH with HARQ-ACK information, and/or SRS, the backhaul link can be dropped. In further example, if the C-link transmits other signals (e.g., PUCCH with other information and/or PUSCH), the C-link can be dropped.
C-link {PRACH, PUCCH transmission with status report}>backhaul link>C-link other channels/signals.
   In this case, the priority of the C-link can depend on the specific/exact transmission signal of the C-link, and the link (e.g., either C-link or backhaul link) with lower priority can be dropped. For example, if the C-link transmits PRACH and/or PUCCH with a status report, the backhaul link can be dropped. In further example, if the C-link transmits other signals (e.g., PUCCH with other information, SRS, and/or PUSCH), the C-link can be dropped.
   The status report in this case can include at least one of abnormality information (e.g., overheating, self-excitation detection, beam failure, radio failure, etc.), measurement report, and/or HARQ-ACK information.
C-link {PRACH, PUCCH transmission with status report? PUSCH transmission with status report}>backhaul link>C-link other channels/signals.
   In this case, the priority of the C-link can depend on the specific/exact transmission signal of the C-link, and the link (e.g., either C-link or backhaul link) with lower priority can be dropped. For example, if the C-link transmits PRACH, PUCCH with a status report, and/or PUSCH with a status report, the backhaul link can be dropped. In further example, if the C-link transmits other signals (e.g., PUCCH with other information, SRS, and/or PUSCH with other information), the C-link can be dropped.
   The status report in this case can include at least one of abnormality information (e.g., overheating, self-excitation detection, beam failure, radio failure, etc.), measurement report, and/or HARQ-ACK information.

### Embodiment 1a: C-Link Dropped According to Predefined Rule

In some implementations, according to or based on the predefined rule (e.g., in reference or referring to example implementation 1), the SN 306 may determine whether to drop the C-link or the backhaul link. If the SN 306 drops the C-link (e.g., dropped signal of the C-link or first signal) according to the predefined rule, SN CU (or NCR-MT) can re-transmit the signal (e.g., the dropped signal) in the same frequency domain resource allocated to the C-link signal that was not previously forwarded (e.g., the initial C-link transmit signal and the C-link re-transmitted signal can be in/on the same frequency domain resource)

In some cases, if the dropped signal is PRACH, at least one of the following can be performed/executed for the dropped signal:
The PRACH signal can be transmitted/sent/communicated/signaled in the next random access channel (RACH) occasion (RO).
The PRACH signal will/can be transmitted in the next PRACH slot.
SN CU can re-evaluate the synchronization signal block (SSB) (e.g., perform DL synchronization procedure) and can transmit PRACH at a time-domain location determined according to the selected SSB and the relationship between SSB and PRACH (e.g., follow RACH procedure).

In some other cases, if the dropped signal is PUCCH, PUSCH, or SRS, at least one of the following can be performed for the dropped signal:
The signal (e.g., first signal) can be transmitted/re-transmitted in the next slot.
The signal can be transmitted in the next uplink (UL) slot.
The signal can be transmitted in a time domain resource according to an indication from BS 102.
The signal can be transmitted after a predefined/predetermined duration (e.g., 1 ms, 1 slot, 1 frame, etc.) (e.g., relative to the time at which the signal was previously dropped).

### Example Implementation 2: C-link and Backhaul Link Sharing the Total Maximum Power Restriction and Prioritizing the Output Power of C-Link

In various implementations, the C-link and backhaul link can share the total maximum power restriction (e.g., the total maximum power restriction can apply to the sum of the C-link power and backhaul link power). In some configurations, the SN 306 (e.g., network node) can determine to prioritize the output power of the C-link (e.g., prioritize sending the first signal). The output power of the C-link can be determined/calculated according to at least one of the formulas (1)-(4) for different signals/channels. By prioritizing the C-link, the SN 306 can reduce the output power of the backhaul link (e.g., second power) for simultaneous transmissions. Hence, the output power of the C-link may not be impacted by the backhaul link power (e.g., the output power of the C-link can be prioritized over the output power of the backhaul link).

The output power of the backhaul link can be determined/computed/calculated as:
Backhaul link output power=min (max total power−C-link power, input power×amplifying gain) (e.g., the smaller one of the maximum total power minus C-link power and/or the product of the input power and the configured value of amplifying gain).

The input power can refer to the incoming signal power from the UE 104 (e.g., F3 signal power) to the SN 306. The SN 306 can reduce the backhaul link power according to the determined output power of the backhaul link. In some cases, the SN 306 can adjust an actual amplifying gain (e.g., different from the configured value of gain) of the SN 306 to satisfy the following restriction/criteria/parameter:
Input power×actual gain<=max total power−C-link power (e.g., the input power multiplied by the actual gain can be smaller than or equal to the maximum total power minus the first power).

### Example Implementation 3: C-Link and Backhaul Link Sharing the Total Maximum Power Restriction and Prioritizing Output Power of Backhaul Link

In various implementations, the C-link and backhaul link can share the total maximum power restriction (e.g., the total maximum power restriction can apply to the sum of the C-link power and backhaul link power). In some configurations, the SN 306 (e.g., network node) can determine to prioritize the output power of the backhaul link (e.g., prioritize sending the second signal). By prioritizing the backhaul link, the SN 306 can determine/compute the output power of the backhaul link as follows:
Backhaul link output power=min (max total power, input power×amplifying gain) (e.g., configure the output power of the backhaul link to be the smaller one of the maximum total power or the product of the input power multiplied by the (configured) amplifying gain).

In such cases, the SN 306 can determine or compute the output power of C-link by using at least one of the following techniques/methods/computations:

### Example Technique 1

The output power of C-link can be determined as:
C-link output power=min (max total power-Backhaul link output power, C-link power) (e.g., the smaller one of the maximum total power minus the second power and/or the first power specific to the type of first signal).

In this case, the C-link power can be determined/calculated according to at least one of the formulas (1)-(4) for different signals/channels (e.g., the value of the first power can be specific to the type of signal of the C-link). Because the backhaul link is prioritized in this implementation, the determined C-link power can be compared with the maximum total power minus the backhaul output power (e.g., max total power-backhaul link output power), e.g., such that the C-link power is less than or equal to max total power-backhaul link output power.

### Example Technique 2

The SN 306 can determine the output power of the C-link as:
C-link output power=C-link power-power offset (e.g., a value of the first power specific to a type of the first signal minus a power offset).

In this case, the C-link power can be determined according to at least one of the formulas (1)-(4) for different signals/channels (e.g., the C-link power can be specific to the type of signal of the C-link). The power offset can be at least one of no less than: C-link power+backhaul link output power-max total power (e.g., C-link power plus the determined second power, minus the maximum total power), a fixed value, and/or configured by the BS 102.

### Example Implementation 4: BS Transmits Power Control Indication to SN to Adjust the Output Power for Backhaul Link

In various implementations, the BS 102 can transmit power control indication to the SN 306 to adjust the output power for the backhaul link (e.g., second power) to ensure that the sum of the power for the C-link and the backhaul link is below/less than or equal to (does not exceed) the total maximum power restriction. The SN 306 can receive the indication (e.g., power control indication) for adjusting the backhaul link power from the BS 102. The SN 306 can adjust the backhaul link power according to the power control indication. The power control indication (e.g., for controlling backhaul link power) may include an indication of at least one of transmission power, amplifying gain, frequency resource, and/or time resource.

### Transmission Power

In some configurations, if the transmission power (e.g., power of the backhaul link or second power) is indicated (e.g., the power control indication may include an indication of the transmission power), the amplifying gain can be determined/calculated as: amplifying gain=transmission power/input power (e.g., transmission power value divided by an input power from the UE 104 to the SN 306). The sum of the transmission power for the backhaul link and the C-link can/should be less than the maximum total power (e.g., total maximum power restriction or maximum power threshold).

### Amplifying Gain

In some configurations, if the amplifying gain is indicated (e.g., included in the power control indication), the SN 306 can determine/compute the transmission power (e.g., power of the backhaul link) as:
Transmission power=min (max total power−C-link power, input power×amplifying gain) (e.g., the smaller one of the maximum total power minus a value of the first power specific to the type of first signal and/or the product of the input power to the SN 306 multiplied by the configured amplifying gain of the SN 306).

The SN 306 can adjust the amplifying gain to satisfy the following restriction:
Input power×actual gain<=max total power−C-link power (e.g., input power multiplied by the actual gain is smaller than/less than or equal to the maximum total power minus the first power).

### Frequency Resource

In some configurations, the frequency resource may be indicated for the backhaul link power (e.g., second power). The indication of the frequency resource can include at least one of the following parameters:
Frequency offset to indicate the start of the frequency resource. The frequency offset may be compared to at least one of: point A (e.g., a frequency location as defined in the specification), the start of the bandwidth part (BWP), and/or the start of the resource block (RB). The granularity of the frequency offset can be in RB level or resource element (RE) level.
RB number and/or RE number to indicate the applied frequency resource, e.g., frequency offset to frequency offset+RB number or RE number.
BWP index, where the power control indication may be applied on one or more of the supported BWPs.
Band index, where the power control indication may be applied on one or more of the supported bands.
Frequency domain resource allocation (FDRA) indicator, such as in DCI.

### Time Resource

In some configurations, the time resource may be indicated for the backhaul link power (e.g., second power). The time resource can include at least one of the following parameters:
Slot offset to indicate the start of the time resource in a slot level. The offset may be compared to at least one of the start of a period, the application time of the indication (e.g., can be predefined or indicated), a reference point (e.g., SFNO, SFN512, etc.), and/or the start of a frame, among others.
Symbol offset to indicate the start of the time resource in a symbol level. The offset may be compared to at least one of the start of a slot, the start of a period, the application time of the indication (e.g., predefined or indicated), a reference point (e.g., SFNO, SFN512, etc.), and/or the start of a frame, among others.
Duration, in ms level, slot level, or symbol level.
Periodicity.
System frame number (SFN).
Start and length indicator value (SLIV).
Subcarrier spacing (SCS). For example, the value of SCS can be 15 kHz, 30 kHz, 60 kHz, 120 kHz (e.g., can affect slot size), etc.
Number of absolute time units. For example, if the number is 5 and the absolute time unit is 1 ms, the indicated duration can be 5 ms.
Absolute time unit, e.g., 1 ms, 0.5 ms, 0.25 ms, etc. The absolute time unit parameter can be one parameter of the time resource or predefined in the specification.

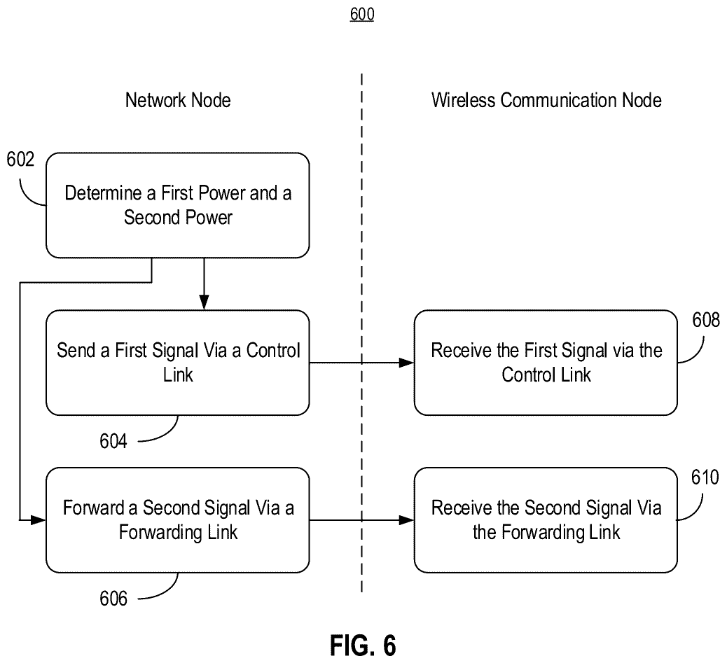

Referring now to FIG. 6 illustrates a flow diagram of a method 600 for simultaneous backhaul link and control link transmissions for network nodes (e.g., SNs). The method 600 may be implemented using any of the components and devices detailed herein in conjunction with FIGS. 1-5. In overview, the method 600 may include determining a first power and a second power (602). The method 600 may include sending a first signal via a control link (604). The method 600 may include forwarding a second signal via a forwarding link (606). The method 600 may include receiving the first signal via the control link (608). The method 600 may include receiving the second signal via the forwarding link (610).

At operation (602), and in some arrangements, a network node (e.g., SN) can determine/compute/calculate a first power (e.g., C-link power or transmission power of/for/in the C-link) of the network node for a control link from the network node to a wireless communication node (e.g., BS, gNB, eNB, or TRP), and a second power (e.g., backhaul link power or transmission power of/for/in the backhaul link) of the network node for a forwarding link (e.g., F1, backhaul link) from the network node to the wireless communication node.

In some arrangements, the network node can perform at least one of the operations (604) and/or (606). At operation (604), the network node can send/transmit/provide/signal/communicate a first signal/message via the control link from the network node to the wireless communication node. At operation (606), the network node can forward/send a second signal via the forwarding link from the network node to the wireless communication node. Responsive to at least one of operations (604) and/or (606), the BS 102 can receive/obtain/acquire/get at least one of, at operation (608), the first signal via the control link from the network node to the wireless communication node, and/or, at operation (610), the second signal via the forwarding link from the network node to the wireless communication node.

In various implementations, when a transmission on the control link and a transmission on the forwarding link occur simultaneously (e.g., overlapping in time), at least one of: the first power can be lower than or equal to a first maximum power configured for the control link and/or the second power can be lower than or equal to a second maximum power configured for the forwarding link. The first maximum power (e.g., maximum power restriction) can be different from the second maximum power.

In some implementations, when a transmission on the control link and a transmission on the forwarding link occur simultaneously, at least one of multiple methods/scenarios (e.g., first method, second method, etc.) can be supported/utilized/performed. In a first method/scenario, a sum of a maximum value of the first power (e.g., maximum power of the C-link) and a maximum value of the second power (e.g., maximum power of the backhaul link) can be less than or equal to a total maximum power (e.g., C-link and backhaul link can share or be associated with one total maximum power restriction or can be associated with the same RF component). The total maximum power can be a part of the capability of the network node. For example, the hardware and/or software of the network node may restrict/limit/cap the peak output power to a value (e.g., the total maximum power). In a second method/scenario, the maximum value of the first power can be unrelated to the maximum value of the second power (e.g., C-link and backhaul link can have separate maximum power restrictions, such as the C-link and the backhaul link may have separate RF components). For example, when the network node supports the first method/scenario, the sum of the first maximum power and second maximum power can be lower than a total maximum power restriction. When the network node supports the second method/scenario, the first maximum power and the second maximum power may not be related (e.g., maximum power restriction of the C-link and the backhaul link are not related). In this case, there may not be a total maximum power restriction. In a third method/scenario, at least one of the maximum value of the first power or the maximum value of the second power can be configured by the wireless communication node. In a fourth method/scenario, at least one of the maximum value of the first power or the maximum value of the second power can be computed/calculated/determined by/based on/according to a total maximum power minus another one of the maximum value of the first power or the maximum value of the second power. The total maximum power can be a part of the capability of the network node. In some configurations, two or more methods can be combined or supported according to the capability or support of the network node, such as the first method and the third method, the first method and the fourth method, the third capability and the fourth method, etc.

In some implementations, when a total power of the first power and the second power exceeds the total maximum power (e.g., total maximum power restriction between the C-link and the backhaul link), and/or when a transmission on the control link and a transmission on the forwarding link occur simultaneously, the network node can determine to one of perform A, perform B, or perform A or B (according to a prioritization rule).

For example, to perform A, the network node can allocate no power to the second power, and/or determine not to perform the forwarding/transmission of the second signal (e.g., prioritize the control link and/or drop the backhaul link). To perform B, the network node can allocate no power to the first power, or determine not to send the first signal (e.g., prioritize backhaul link and/or drop the C-link). In some cases, the network node can determine to perform A or B according to or based on a prioritization rule (e.g., predefined rule). Performing A or B may include performing the transmissions on the C-link and the backhaul link according to the prioritization rule.

In various configurations, the prioritization rule can indicate to perform the forwarding or sending of at least one signal having the highest priority among signals that matched candidate signals identified in the prioritization rule. In some implementations, the prioritization rule can identify at least one of the following candidate signals for the first signal (e.g., control link), as having higher priority than a candidate signal for the second signal: a physical random access channel (PRACH) transmission, a physical uplink control channel (PUCCH) transmission, a PUCCH transmission with hybrid automatic repeat request acknowledgement (HARQ-ACK) information, a physical uplink shared channel (PUSCH) transmission with HARQ-ACK information, a sounding reference signal (SRS), a PUCCH transmission with a status report, and/or a PUSCH transmission with a status report. For example, if the first signal includes/contains at least one of the aforementioned specific types of signal (e.g., and/or messages or information) with a higher priority than the candidate signal for the second signal, the network node can prioritize the first signal for C-link transmission and drop the second signal. If the first signal includes other types of signals not included in or outside of the prioritization rule, the network node can prioritize the second signal for backhaul link transmission, thereby dropping the first signal.

In some implementations, the prioritization rule may identify at least one of the following candidate signals for the first signal, as having a lower priority than a candidate signal for the second signal: a signal other than a physical random access channel (PRACH) transmission, a signal other than a physical uplink control channel (PUCCH) transmission, a signal other than a PUCCH transmission with hybrid automatic repeat request acknowledgement (HARQ-ACK) information, a signal other than a physical uplink shared channel (PUSCH) transmission with HARQ-ACK information, a signal other than a sounding reference signal (SRS), a signal other than a PUCCH transmission with status report, and/or a signal other than a PUSCH transmission with status report. For example, if the first signal includes/contains at least one of the aforementioned specific types of signal (e.g., and/or messages or information) with a lower priority than the candidate signal for the second signal, the network node can prioritize the second signal for backhaul link transmission and drop the first signal. If the first signal includes other types of signals not included in or outside of the prioritization rule (e.g., for lower priority than the second signal in this case), the network node can prioritize the first signal for C-link transmission, thereby dropping the second signal, for example.

In some implementations, the prioritization rule can identify, in order of descending priority, a first candidate signal for the first signal (e.g., C-link signal), a second candidate signal for the second signal (e.g., backhaul link signal), and a third candidate signal for the first signal (e.g., another C-link signal), respectively, for example, as including one of the following: {a physical random access channel (PRACH) transmission, or a physical uplink control channel (PUCCH) transmission; any signal (e.g., any backhaul link signal); a signal other than a PRACH transmission or a PUCCH transmission}; or {a PRACH transmission, or a PUCCH transmission with hybrid automatic repeat request acknowledgement (HARQ-ACK) information; any signal; a signal other than a PRACH transmission or a PUCCH transmission with HARQ-ACK information}; or {a PRACH transmission, a PUCCH transmission with HARQ-ACK information, or a physical uplink shared channel (PUSCH) transmission with HARQ-ACK information; any signal; a signal other than a PRACH transmission, a PUCCH transmission with HARQ-ACK information or a PUSCH transmission with HARQ-ACK information}; or {a PUCCH transmission with HARQ-ACK information; any signal; a signal other than a PUCCH transmission with HARQ-ACK information}; or {a PUCCH transmission with HARQ-ACK information, or a physical uplink shared channel (PUSCH) transmission with HARQ-ACK information; any signal; a signal other than a PUCCH transmission with HARQ-ACK information or a PUSCH transmission with HARQ-ACK information}; or {a PUCCH transmission with HARQ-ACK, or a sounding reference signal (SRS) information; any signal; a signal other than a PUCCH transmission with HARQ-ACK information or a SRS}; or {a PRACH transmission, a PUCCH transmission with HARQ-ACK information, or a SRS; any signal; a signal other than a PRACH transmission, a PUCCH transmission with HARQ-ACK information or a SRS}; or {a PRACH transmission, or a PUCCH transmission with status report; any signal; a signal other than a PRACH transmission or a PUCCH transmission with status report}; or {a PRACH transmission, a PUCCH transmission with status report, or a PUSCH transmission with status report; any signal; a signal other than a PRACH transmission or a PUCCH transmission with status report or a PUSCH transmission with status report}.

In some configurations, when the network node determines to perform B (e.g., dropping the first signal), the network node may transmit/re-transmit the first signal (e.g., another C-link signal or the dropped first signal) in a frequency domain resource allocated to the first signal that was not previously forwarded/transmitted (e.g., the same frequency domain resource as the dropped first signal that was about to be transmitted simultaneously with the second signal).

In some implementations, when the first signal includes a physical random access channel (PRACH) transmission, then at least one of: the network node may transmit the PRACH transmission in a next random access channel (RACH) occasion (RO); the network node may transmit the PRACH transmission in a next PRACH slot; and/or the network node may transmit the PRACH transmission according to: a synchronization signal block (SSB) determined by the network node, and a relationship between the SSB and the PRACH transmission, etc. In some implementations, when the first signal includes a physical uplink control channel (PUCCH) transmission, a physical uplink shared channel (PUSCH) transmission, and/or a sounding reference signal (SRS), then at least one of: the network node may transmit the first signal (e.g., signal on the C-link) in a next slot; the network node may transmit the first signal in a next uplink slot; the network node may transmit the first signal in a time domain resource according to an indication from the wireless communication node; and/or the network node may transmit the first signal after a defined/configured/predetermined duration.

In some configurations, the network node can determine to prioritize the sending of the first signal (e.g., C-link signal), for instance, for simultaneous transmissions on the C-link and the backhaul link. In this case, the network node may reduce/decrease the second power (e.g., backhaul link output power) to be a smaller one (e.g., minimum) of: a maximum total power minus the first power (e.g., C-link power), and/or an input power (e.g., from a wireless communication device, such as a UE) to the network node multiplied by a configured (amplifying) gain of the network node. The configured gain can refer to an amplifying gain or can refer to a maximum gain without adjustment.

In some implementations, the network node can adjust/change an actual gain of the network node, such that: the input power multiplied by the actual gain is smaller than/less than or equal to the maximum total power minus the first power. The network node can adjust the actual gain such that the total power output by the network node does not exceed the maximum power threshold.

In some configurations, the network node may determine to prioritize the forwarding of the second signal (e.g., backhaul link signal). In this case, the network node can determine the second power (e.g., backhaul link output power) to be a smaller one of: a maximum total power, and/or an input power to the network node multiplied by a configured gain of the network node. In some implementations, the network node can determine the first power (e.g., C-link output power) to be a smaller one (e.g., minimum) of: the maximum total power minus the second power (e.g., backhaul link output power), and/or a value of the first power specific to a type of the first signal (e.g., C-link power, which can be computed using at least one of the formulas (1)-(4) for different signals/channels).

In some implementations, the network node can determine the first power (e.g., C-link output power) to be: a value of the first power specific to a type of the first signal (e.g., C-link power) minus a power offset. The power offset can be at least one of no less than: the value of the first power specific to a type of the first signal (e.g., C-link power), plus the determined second power (e.g., backhaul link power), minus the maximum total power (e.g., total maximum power restriction); a fixed value; and/or configured by the wireless communication node.

In some configurations, the network node may receive/obtain/acquire an indication for adjusting the second power (e.g., backhaul link power), such as for prioritizing the first signal on the C-link. The network node can adjust the second power according to the indication. For example, the indication can include at least one of:
An indication of a transmission power value for the second power, where at least one of: a gain of the network node can be determined based on/according to the transmission power value divided by an input power to the network node, and/or a sum of the transmission power value and the first power can be less than a maximum total power;
An indication of the gain, where at least one of: the second power is a smaller/lesser one (e.g., minimum) of: the maximum total power minus a value of the first power specific to a type of the first signal (e.g., computed C-link power), and/or the input power to the network node multiplied by a configured gain of the network node; and/or the gain can be such that: the input power multiplied by the (actual) gain is smaller than or equal to the maximum total power minus the first power (e.g., C-link power);
An indication of a frequency domain resource for the second power. This indication can include at least one of: a frequency offset, a resource block (RB) number or a resource element (RE) number, a bandwidth part (BWP) index, a band index, and/or a frequency domain resource allocation (FDRA) indicator; and/or
An indication of a time domain resource for the second power. This indication can include at least one of: a slot offset, a symbol offset, a duration, a periodicity, a system frame number (SFN), a start and length indicator value (SLIV), a number of absolute time units, and/or an absolute time unit.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
determining, by a network node, (i) a first power of the network node for a control link from the network node to a wireless communication node, and (ii) a second power of the network node for a forwarding link from the network node to the wireless communication node; and
performing, by the network node, at least one of (i) sending a first signal via the control link from the network node to the wireless communication node, and (ii) forwarding a second signal via the forwarding link from the network node to the wireless communication node.

2. The method of claim 1, wherein when a transmission on the control link and a transmission on the forwarding link occur simultaneously, at least one of:
the first power is to be lower than or equal to a first maximum power configured for the control link; or
the second power is to be lower than or equal to a second maximum power configured for the forwarding link.

3. The method of claim 1, wherein when a transmission on the control link and a transmission on the forwarding link occur simultaneously, at least one of:
a sum of a maximum value of the first power and a maximum value of the second power is less than or equal to a total maximum power, wherein the total maximum power is a capability of the network node; or
the maximum value of the first power is unrelated to the maximum value of the second power; or
at least one of the maximum value of the first power or the maximum value of the second power is configured by the wireless communication node; or
at least one of the maximum value of the first power or the maximum value of the second power is determined based on a total maximum power minus another one of the maximum value of the first power or the maximum value of the second power, wherein the total maximum power is a capability of the network node.

4. The method of claim 1, wherein when a total power of the first power and the second power exceeds a total maximum power, or when a transmission on the control link and a transmission on the forwarding link occur simultaneously, the method comprises one of:
determining to perform A, which comprises: allocating no power to the second power, or determining not to perform the forwarding of the second signal;
determining to perform B, which comprises: allocating no power to the first power, or determining not to send the first signal; or
determining to perform A or B, according to a prioritization rule.

5. The method of claim 4, wherein the prioritization rule indicates to perform forwarding or sending of at least one signal having a highest priority among signals that matched candidate signals identified in the prioritization rule.

6. The method of claim 5, wherein the prioritization rule identifies at least one of following candidate signals for the first signal, as having higher priority than a candidate signal for the second signal:
a physical random access channel (PRACH) transmission,
a physical uplink control channel (PUCCH) transmission,
a PUCCH transmission with hybrid automatic repeat request acknowledgement (HARQ-ACK) information,
a physical uplink shared channel (PUSCH) transmission with HARQ-ACK information,
a sounding reference signal (SRS),
a PUCCH transmission with status report, or
a PUSCH transmission with status report.

7. The method of claim 5, wherein the prioritization rule identifies at least one of following candidate signals for the first signal, as having lower priority than a candidate signal for the second signal:
a signal other than a physical random access channel (PRACH) transmission,
a signal other than a physical uplink control channel (PUCCH) transmission,
a signal other than a PUCCH transmission with hybrid automatic repeat request acknowledgement (HARQ-ACK) information,
a signal other than a physical uplink shared channel (PUSCH) transmission with HARQ-ACK information,
a signal other than a sounding reference signal (SRS),
a signal other than a PUCCH transmission with status report, or
a signal other than a PUSCH transmission with status report.

8. The method of claim 5, wherein the prioritization rule identifies, in order of descending priority, a first candidate signal for the first signal, a second candidate signal for the second signal, and a third candidate signal for the first signal, respectively, as comprising:
{a physical random access channel (PRACH) transmission, or a physical uplink control channel (PUCCH) transmission; any signal; a signal other than a PRACH transmission or a PUCCH transmission}; or
{a PRACH transmission, or a PUCCH transmission with hybrid automatic repeat request acknowledgement (HARQ-ACK) information; any signal; a signal other than a PRACH transmission or a PUCCH transmission with HARQ-ACK information}; or
{a PRACH transmission, a PUCCH transmission with HARQ-ACK information, or a physical uplink shared channel (PUSCH) transmission with HARQ-ACK information; any signal; a signal other than a PRACH transmission, a PUCCH transmission with HARQ-ACK information or a PUSCH transmission with HARQ-ACK information}; or
{a PUCCH transmission with HARQ-ACK information; any signal; a signal other than a PUCCH transmission with HARQ-ACK information}; or
{a PUCCH transmission with HARQ-ACK information, or a physical uplink shared channel (PUSCH) transmission with HARQ-ACK information; any signal; a signal other than a PUCCH transmission with HARQ-ACK information or a PUSCH transmission with HARQ-ACK information}; or
{a PUCCH transmission with HARQ-ACK, or a sounding reference signal (SRS) information; any signal; a signal other than a PUCCH transmission with HARQ-ACK information or a SRS}; or
{a PRACH transmission, a PUCCH transmission with HARQ-ACK information, or a SRS; any signal; a signal other than a PRACH transmission, a PUCCH transmission with HARQ-ACK information or a SRS}; or
{a PRACH transmission, or a PUCCH transmission with status report; any signal; a signal other than a PRACH transmission or a PUCCH transmission with status report}; or
{a PRACH transmission, a PUCCH transmission with status report, or a PUSCH transmission with status report; any signal; a signal other than a PRACH transmission or a PUCCH transmission with status report or a PUSCH transmission with status report}.

9. The method of claim 4, wherein when the network node determines to perform B, the method further comprises:
transmitting, by the network node, the first signal in a frequency domain resource allocated to the first signal that was not previously transmitted.

10. The method of claim 9, wherein when the first signal comprises a physical random access channel (PRACH) transmission, then at least one of:
the PRACH transmission is to be transmitted in a next random access channel (RACH) occasion (RO);
the PRACH transmission is to be transmitted in a next PRACH slot; or
the PRACH transmission is to be transmitted according to: a synchronization signal block (SSB) determined by the network node, and a relationship between the SSB and the PRACH transmission.

11. The method of claim 9, wherein when the first signal comprises a physical uplink control channel (PUCCH) transmission, a physical uplink shared channel (PUSCH) transmission, or a sounding reference signal (SRS), then at least one of:
the first signal is to be transmitted in a next slot;
the first signal is to be transmitted in a next uplink slot;
the first signal is to be transmitted in a time domain resource according to an indication from the wireless communication node; or
the first signal is to be transmitted after a defined duration.

12. The method of claim 1, comprising:
determining, by the network node, to prioritize the sending of the first signal; and
reducing, by the network node, the second power to be a smaller one of: (i) a maximum total power minus the first power, and (ii) an input power to the network node multiplied by a configured gain of the network node.

13. The method of claim 12, comprising:
adjusting, by the network node, an actual gain of the network node, such that: the input power multiplied by the actual gain is smaller than or equal to the maximum total power minus the first power.

14. The method of claim 1, comprising:
determining, by the network node, to prioritize the forwarding of the second signal; and
determining, by the network node, the second power to be a smaller one of: (i) a maximum total power, and (ii) an input power to the network node multiplied by a configured gain of the network node.

15. The method of claim 14, comprising:
determining, by the network node, the first power to be a smaller one of: (i) the maximum total power minus the second power, and (ii) a value of the first power specific to a type of the first signal.

16. The method of claim 14, comprising:
determining, by the network node, the first power to be: a value of the first power specific to a type of the first signal, minus a power offset.

17. The method of claim 1, comprising:
receiving, by the network node, an indication for adjusting the second power; and
adjusting, by the network node, the second power according to the indication.

18. A network node, comprising:
at least one processor configured to:
determine (i) a first power of the network node for a control link from the network node to a wireless communication node, and (ii) a second power of the network node for a forwarding link from the network node to the wireless communication node; and
perform at least one of (i) sending using a transmitter a first signal via the control link from the network node to the wireless communication node, and (ii) forwarding using the transmitter a second signal via the forwarding link from the network node to the wireless communication node.

19. A wireless communication node, comprising:
at least one processor configured to:
receive, via a receiver, at least one of (i) a first signal via a control link from a network node to the wireless communication node, and (ii) a second signal via a forwarding link from the network node to the wireless communication node,
wherein the network node determines (i) a first power of the network node for the control link from the network node to the wireless communication node, and (ii) a second power of the network node for the forwarding link from the network node to the wireless communication node.

20. A method comprising:
receiving, by a wireless communication node, at least one of (i) a first signal via a control link from a network node to the wireless communication node, and (ii) a second signal via a forwarding link from the network node to the wireless communication node,
wherein the network node determines (i) a first power of the network node for the control link from the network node to the wireless communication node, and (ii) a second power of the network node for the forwarding link from the network node to the wireless communication node.
